(19) United States
(12) Patent Application Publication
(10) Pub. No.: US 2008/0213733 A1
(43) Pub. Date: Sep. 4, 2008

(54) Dieter's reality check garbage can

(76) Inventor: Kay Christine George, Wichita, KS (US)

Correspondence Address: KAY C GEORGE, 524 N Knight St, WICHITA, KS, 67203-5053, US

(21) Appl. No.: 11/713,057

(22) Filed: Mar. 2, 2007

(51) Int. Cl. G09B 25/00

(52) U.S. Cl. 434/127

(57) ABSTRACT

The dieter's reality check garbage can is made of plastic and is a miniature replica of a galvanized residential trash can. The contents inlude artifical foods made of plastic or rubber (pizza, donuts, soda, french fries, cake, candy bars). A tote bag made of canvas.

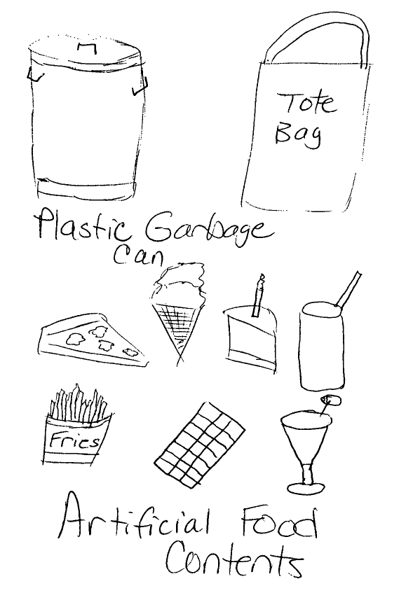

### BACKGROUND OF THE INVENTION

My imagination on what would help me to stop cheating when dieting.

### BRIEF SUMMARY OF THE INVENTION

Foods that you can not eat while wanting to lose weight, they are garbage and go in a garbage can, check the can before eating for a reality check.

### BRIEF DESCRIPTION OF THE SEVERAL VIEWS OF THE DRAWING

One page of drawn art of the invention

### DETAILED DESCRIPTION OF THE INVENTION

A can of any size or dimensions, resembling an aluminum trash can with lid, made of any materials, and of any color, will include a variety artificial/faux food or drinks high in calorie, fat, or in carbohydrates, or any other type of faux food made with plastic, rubber, or any other material. The initial marketing size for desktops or countertops will be of approx. 24 inches in height and made of plastic or aluminum. The word “GARBAGE” (or any other word) will be printed on the can. The word, “FAT” (or any other word) will be printed on the lid. Smaller size cans will include a TOTE for portability.

1. I, Kay C. George, am the original and only inventor of DIETER'S REALITY CHECK GARBAGE CAN.
